(19) United States
(12) Patent Application Publication
(10) Pub. No.: US 2009/0173728 A1
(43) Pub. Date: Jul. 9, 2009

(54) ELECTRICAL SYSTEM

(75) Inventors: Joseph Hendrik Anna Maria Jacobs, Eygelshoven (NL); Dirk Hente, Würselen (DE)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/301,676

(22) PCT Filed: May 25, 2007
(86) PCT No.: PCT/IB07/51974

§ 371 Date: Nov. 20, 2008

(30) Foreign Application Priority Data
Jun. 7, 2006 (EP) 06115079.3

(51) Int. Cl. H05B 1/00; H01J 1/00

(52) U.S. Cl. 219/209; 313/323

(57) ABSTRACT

The invention relates to an electrical system (1) with a light emitting device (10) with a first (11) and a second electrode (12) and a light emitting element (13) being provided between the first (11) and the second electrode (12), a heating device (20) with a heating element (21,11,12), wherein the light emitting device (10) and the heating device (20) are placed between a first (30) and a second panel (31), wherein at least one panel (30,31) is transparent, wherein the heating element (21,11,12) is disposed in an electric circuit in order to emit heat radiation (41), which is generated by the heating element (21,11,12) and directed to the first and/or the second panel (30,31), wherein the light (40), which is generated by the light emitting device (10), and the heat radiation (41) are released at one outer surface (33,34) leaving the electrical system (1).

This invention relates to an electrical system using a light and heat radiation.

Various types of devices generating heat radiation have recently been developed. For example a very efficient heating device is a glass-heating device. In such device, a heater is integrated in a window, a mirror or glass panels used as a radiator. The heater consists of two thin transparent metal or metal-oxide layers, which are disposed on glass panels. The panels are put together in such a way that the glass is on the outside and the metallic or metal-oxide layers are positioned inside said device. The metal or metal-oxide layers are separated by a cavity. One metallic or metal-oxide layer is used as a heater. The other metallic or metal-oxide layer operates as a reflector. This construction guarantees that approximately all heat is transferred to one side of said heat device.

Light emitting devices comprising a thin construction using a LED or an OLED (Organic Light Emitting Device) are well known.

In the U.S. Pat. No. 6,433,476 B1 a display system is disclosed with a first and a second layer, a phosphor layer overlying said first electrode and a dielectric layer overlying said phosphor layer. A first and a second connector are electrically coupled to one of said first and second electrodes. During operation, the phosphor layer emits light and heat is generated. Disadvantageously, this little heat can only be used to warm the liquid crystal material of LEDs in order to raise the temperature sufficiently for the display to operate normally.

It is an object of the present invention to provide an electrical system producing light and heat radiation with a compact and simple setup, wherein sufficiently heat radiation and light can be produced leaving said electrical system.

This object is achieved by an electrical system as taught by claim 1 of the present invention. Advantageous embodiments of the inventive system are defined in the subclaims.

Accordingly, an electrical system producing light and heat radiation, with a light emitting device with a first and a second electrode and a light emitting element being provided between the first and the second electrode, a heating device with a heating element, wherein the light emitting device and the heating device are placed between a first and a second panel, wherein at least one panel is transparent, wherein the heating element is disposed in an electric circuit in order to emit heat radiation, which is generated by the heating element and directed to the first and/or the second panel, wherein the light, which is generated by the light emitting device, and the heat radiation are released at one outer surface leaving the electrical system.

By combining the light emitting device with a heating device a compact electrical system is achieved, which can generate light, efficiently. Additionally, heat radiation is provided leaving said electrical system, wherein the room the device is placed in can be warmed, efficiently. Advantageously, said light emitting device and heating device can be operated at the same time or independently. In one possible embodiment of the invention the electrical system is transparent. In this case, the substrate panels consist of glass or transparent plastic. Also, the components of the light emitting device, especially the first and the second electrode and the light emitting element, and of the heating device, especially the heating element can consist of transparent materials. Preferably, the heating element is a metal or metal-oxide layer. One of the possible applications is that in which the present invention is used in form of a transparent window. During the day, the light emitting device is turned off. Some light can enter the room, which is separated by the inventive electrical system, and UV-light is filtered. The heating device can be operated by emitting heat radiation in direction to the room. At night, the light emitting device can be turned on in order to illuminate said room. This inventive combined electrical system can also be integrated in other applications, for example ceilings, walls, floors, etc. wherein the light emitting device and the heating device become practically invisible. Also, the compact heating and light emitting system allows a reduction of materials.

Preferably, a first cavity is provided between the heating element and the first panel. In a preferred embodiment of the invention a reflecting layer is provided at the first panel reflecting heat radiation in direction to the second panel. In order to achieve as compact electrical system the first and/or the second electrode can act as the heating element emitting heat radiation, additionally. The first and/or the second electrode of the light emitting device can be used commonly by the heating device as the heating element emitting heat radiation. Thus, a very thin and compact electrical system can be provided using only two panels limiting to both sides the light emitting and heating device, which are placed between both panels.

In a preferred embodiment of the inventive device at least one of the electrodes and/or the heating element and/or the reflective layer are transparent metallic or metal-oxide layers positioned between the panels. Examples for the transparent metallic layer are copper, silver or gold. The transparent metal oxide layer can comprise an Indium Tin Oxide (ITO). In one embodiment of the invention the generated heat radiation is released at both outer surfaces leaving said electrical system. Alternatively, the heat radiation leaves the electrical system at only one side, wherein at least one part of the heat radiation being emitted on the surface of the heating element is directed to said reflective layer, which reflects almost all heat radiation. Thus, the electrical system emits heat radiation only to one side, wherein the generated light can leave the inventive system to all sides. Also, the first or the second electrode can be reflective. In this case the emitted light can leave the system only to one side. Advantageously, the electrical system comprises such a construction, that the produced light leaves the inventive system at the same surface, on which the heat radiation is released.

Preferably, the light emitting device is an OLED, wherein the light emitting element is an organic layer. One of the essential advantages is that the OLED is a very efficient light source comprising a very thin and flat structure. Preferably, one electrode is an anode and the second electrode is a cathode, wherein between both electrodes the organic layer is positioned. In a preferred embodiment of the invention the organic layer can comprise a multi-layer structure.

According to another embodiment of the invention, the light emitting element can be an LED. The combination of the heating device with the light emitting device including LEDs as a light emitting element offer nearly the same benefit as by using an OLED. The electrical system can comprise multiple LEDs, provided between the first and the second electrode, wherein each LED has a defined distance to the adjacent LED. Advantageously, the LED comprises electrodes being structured.

Advantageously, the light emitting device and the heating device are superimposed, wherein an intermediate layer is disposed between the light emitting device and the heating device. In this embodiment the light emitting device and the heating device are stacked together. Preferably, the intermediate layer is provided between the first electrode and the heating element. In this embodiment the intermediate layer is commonly used by the light emitting device and the heating device. During operation, the heat radiation is emitted at the surface of the heating element and directed to the first and the second panel, wherein the heat radiation transmits the light emitting device. Advantageously, a part of the generated light is directed to the first panel transmitting said heating device. Alternatively, the first cavity is disposed between the reflecting layer and the heating element. At least one part of the heat radiation being emitted on the surface of the heating element is directed to the reflecting layer, which reflects almost all heat radiation. Preferably, heat and light can be reflected at one common layer of the electrical system.

If desired, the light emitting device is disposed on the first and the second panel, wherein multiple LEDs are positioned between the first electrode acting as a heating element in order to emit heat radiation and the second electrode acting as a reflecting layer in order to reflect heat radiation and/or light.

Advantageously, the maximum temperature of said heating element is in the range of 20° C.≦T≦100° C., preferably in the range of 30° C.≦T≦50° C. While the light and heat radiation is leaving the inventive electrical system, the light emitting device, especially the OLED or the LEDs are warmed. Consequently, said light emitting elements operates at a higher temperature, which may lead to higher efficiencies.

According to one preferred embodiment of the invention, the first and/or the second cavity is filled with gas, in particular with inert gas. Alternatively said cavities can be filled with a liquid or with a combination of gas and liquid. Preferably, the electrical system radiates electromagnetic rays, so that the person in the radiation area experiences a sensation of warmth. Advantageously, the components of the light emitting device and persons, objects, etc. in the radiation area of the electrical system can be warmed, efficiently.

In a preferred embodiment of the invention the first electrode and/or the second electrode and/or the heating element and/or the reflecting layer comprise a multilayer structure. Advantageously, the light emitting device and the heating device are connected with an individual driving circuit.

The light emitting device according to the present invention can be used in a variety of systems amongst them systems being household application systems, shop lighting systems, home lighting systems, accent lighting systems, spot lighting systems, fibre-optics application systems, projection systems, self-lit display systems, segmented display systems, warning sign systems, medical lighting application systems, mobile phone display systems, indicator sign systems, decorative lighting systems or electronic systems in a flexible environment, such as textiles and other wearables.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims and the following description of the respective figures—which in an exemplary fashion—shows preferred embodiments of the light emitting device according to the invention.

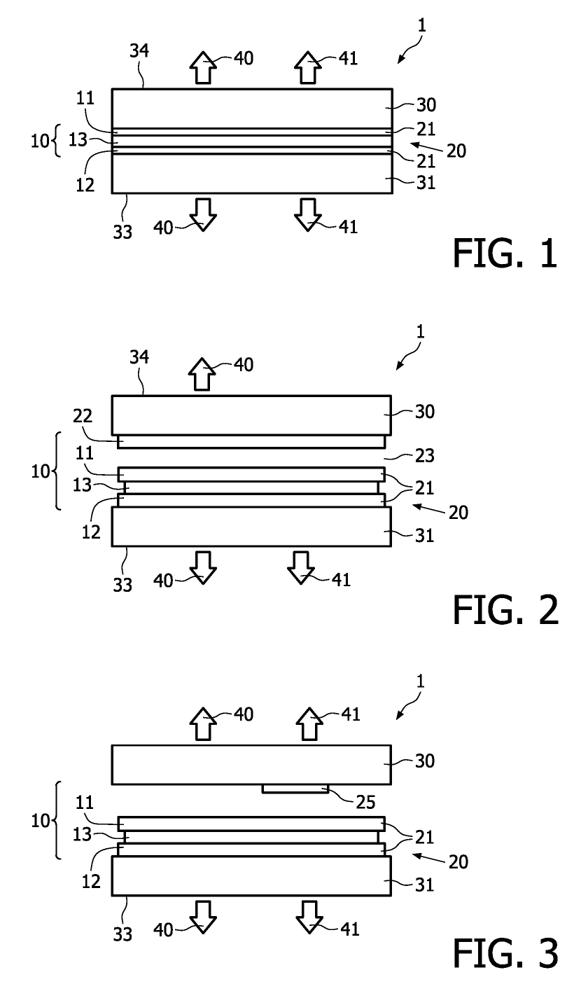

FIG. 1 shows a very schematic view of the electrical system according to a first embodiment of the present invention,

FIG. 2 shows an electrical system according to a second embodiment of the present invention,

FIG. 3 shows an electrical system according to a third embodiment of the present invention,

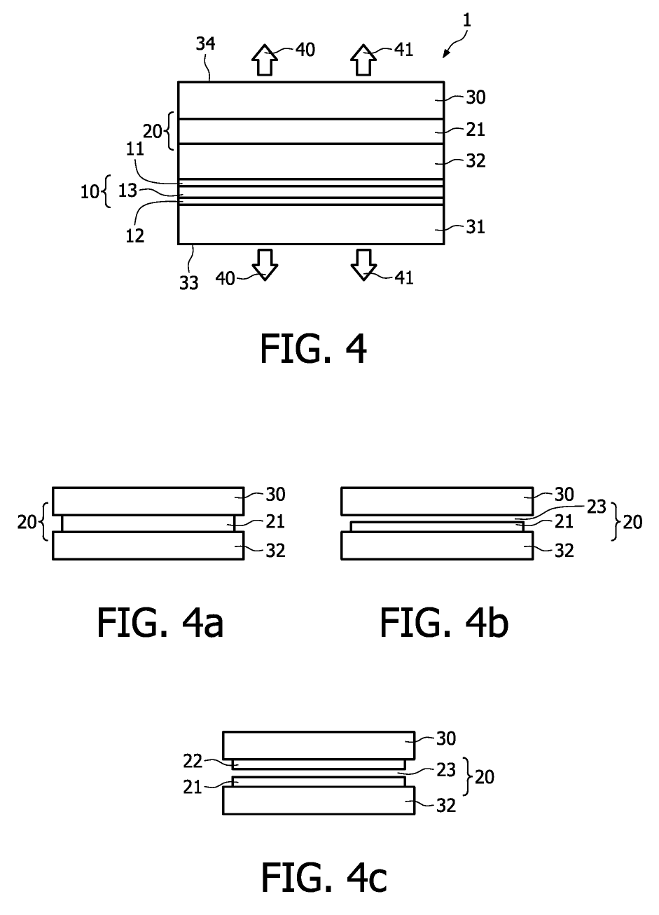

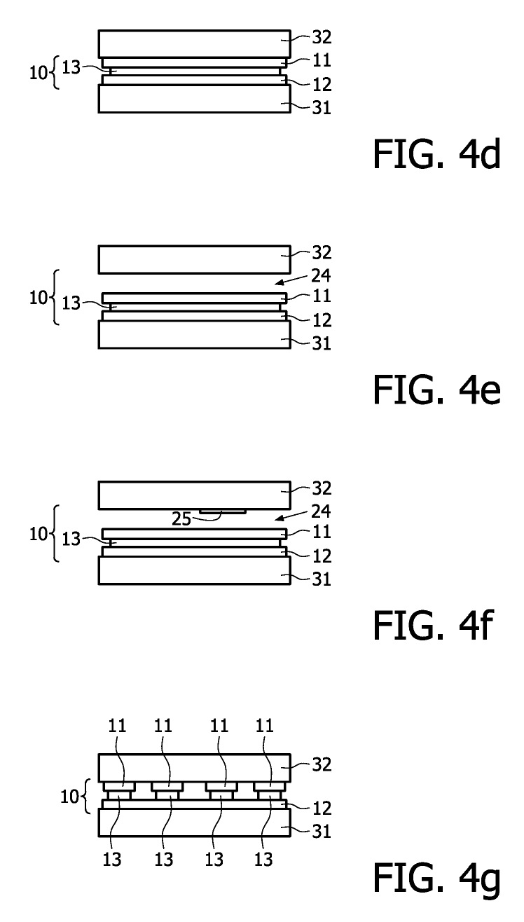

FIG. 4 shows an electrical system according to a forth embodiment of the present invention,

FIG. 4a shows a heating device according to the electrical system of FIG. 4,

FIG. 4b shows another embodiment of a heating device according to the electrical system of FIG. 4,

FIG. 4c shows a further embodiment of a heating device according to the electrical system of FIG. 4,

FIG. 4d shows a lighting device according to the electrical system of FIG. 4,

FIG. 4e shows another embodiment of a lighting device according to the electrical system of FIG. 4,

FIG. 4f shows a further embodiment of a lighting device according to the electrical system of FIG. 4,

FIG. 4g shows an additional embodiment of a lighting device according to the electrical system of FIG. 4,

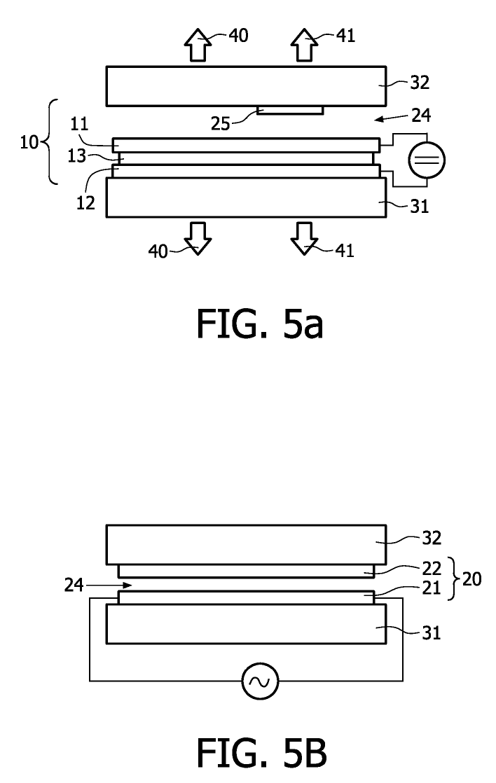

FIG. 5a shows a possible embodiment of a light emitting device connected with a driving circuit and

FIG. 5b shows an embodiment of a heating device connected with a driving circuit.

FIG. 1 illustrates an electrical system 1, which emits light 40 and heat radiation 41 on its surfaces 33,34. The electrical system 1 is transparent comprising a light emitting device 10 and a heating device 20. The light emitting device 10 comprises a first 11 and a second electrode 12, wherein a light emitting element 13 is placed between the first 11 and the second electrode 12. The first electrode 11 is disposed on a first panel 30 and the second electrode 12 is arranged on a second panel 31. Between the first 11 and the second electrode 12 the organic layer 13 is placed, which consists of several organic layers comprising a multi layer structure, which is not shown explicitly. The two electrodes 11, 12 act as an anode and a cathode, wherein a light 40 is generated by the organic layer 13. In this embodiment of the invention the second electrode 12 acts as heating element 21 of the heating device 20. That means that the “layer” 12 is used commonly by the light emitting device 10 and by the heating device 20.

The light emitting device 10 and the heating device 20 are connected with an individual driving circuit. During operation the heating element 21 is heated. One part of the heat radiation 41 is directly emitted in direction to the bottom surface 33 of the electrical system 1. The other part of the heat radiation 41 is directed towards the top surface 34. Thus, almost all generated heat radiation 41 transmits the first 30 and the second panel 31 and the light emitting device 10. Also, the light 40 being emitted by the organic layer 13 transmits the first 30 and the second panel 31.

Alternatively, the first electrode 11 can be designed as a heating element 21. Thus, both electrodes 11,12 can act as a heating element. In another not shown embodiment the first or the second electrode 11,12 can be reflective, wherein the reflective material can comprise aluminium. Other materials are possible. During operation one part of the emitted heat radiation is reflected by one reflective electrode 11,12. Thus, heat radiation 41 leaves the electronic system 1 only at one surface 33,34. The electrodes 11,12 can be designed in such a way, that the light 40 can transmit both electrodes 11,12.

According to FIG. 2 the electrical system 1 comprises two panels 30, 31. Between said both panels 30, 31 the light emitting device 10 and the heating device 20 are arranged. Like in the first embodiment the light emitting device 10 comprises a first 11 and a second electrode 12, wherein the light emitting element 13 is placed between the first and the second electrode 11, 12. A cavity 23 is provided between the first electrode 11 and a reflective layer 22 being disposed on the inner surface of the first panel 30. In this embodiment the first electrode 11 is commonly used by the lighting device 10 and the heating device 20. During operation the first electrode 11 emits heat radiation 41, which is reflected at the reflecting layer 22. In this embodiment light 40 is emitted to both sides 33,34 of the system 1, wherein the heat radiation 41 leaves the system 1 only at the bottom surface 33. Additionally, the second electrode 12 can also act as a heating element 21 for the heating device 20. In another embodiment the first 11 and/or the second electrode 12 can consist of a reflective material. In this case the emitted light 40 is reflected at one electrode 11,12, wherein the light 40 leaves the system only at one surface 33,34 of the electrical system 1.

FIG. 3 shows an electrical system 1, which comprises a construction being nearly similar to the embodiment of FIG. 2. The only difference is that a getter material 25 is disposed on the inner surface of the first panel 30. Heat radiation 41 and light 40 leaves the system 1 at both sides 33,34.

In FIG. 4 another possible embodiment of the electrical system 1 is illustrated. The electrical system 1 comprises a heating device 20 and a lighting device 10, which are stacked together. An intermediate layer 32 is disposed between the light emitting device 10 and the heating device 20, wherein the intermediate layer 32 is commonly used as a “layer” of both devices 10,20. In the shown embodiment the heating device 20 comprises a heating element 21, which is sandwiched between a first panel 30 and the intermediate layer 32 (see also FIG. 4a). The light emitting device 10 consists of a first and a second electrode 11,12, wherein between both electrodes 11,12 an emitting element 13 is placed (FIG. 4d). During operation heat radiation 41 and light 40 is generated, which can leave said system 1 to one or to both sides 33,34.

The FIGS. 4a-4g demonstrate alternative embodiments of possible heating devices 20 and light emitting devices 10, which can be used in the shown electrical system 1 according to FIG. 4. FIG. 4b shows an alternative embodiment of an heating device 20, wherein a first cavity 23 is provided between a first panel 30 and the heating element 21, which is arranged on the intermediate layer 32. According to FIG. 4c the heating device 20 comprises a first panel 30 and an intermediate layer 32, wherein between on the facing surfaces of the first panel 30 and the intermediate layer 32 a heating element 21 and a reflective layer 22 are disposed. On the rear side of the intermediate layer 32 several lighting devices 10 can be disposed, wherein some possible embodiments of lighting devices 10 are illustrated in the FIGS. 4d-4g.

In FIG. 4e a lighting device 10 is shown with an intermediate layer 32 and a second panel 32, which sandwich the first and the second electrode 11,12, wherein a lighting element 13 is disposed between both electrodes 11,12. Between the first electrode 11 and the intermediate layer 32 a second cavity 24 is provided.

The embodiment of the lighting device 10 according to FIG. 4f is near similar to FIG. 4e, wherein the only difference is that a getter material 25 is fixed on the inner surface of the intermediate layer 32. Said getter material is faced to the first electrode 11.

According to the embodiment of FIG. 4g the electrical system 1 comprises nearly the construction of FIG. 4d. The only difference is that multiple LEDs 13 are disposed between first 11 and the second electrode 12 instead of the organic layer.

According to the shown embodiments the heating element 21, the reflecting layer 22, the electrodes 11, 12, the light emitting elements 13, the panels 30, 31 and the intermediate layer 32 are transparent. The cavities 23,24 are filled with inert gas, which is particularly dry. Alternatively, the cavities 23,24 can be filled with a liquid, which advantageously comprises a getter material or a dispersing material or a phosphor. Advantageously, the cavities 23,24 are encapsulated in the electrical system by an adhesive bonding, which connects the opposing panels. To achieve a transparent and conductive first and a second electrode 11, 12 the transparent material can comprise ITO (Indium Tin Oxide). Preferably, one of the electrodes 11, 12 is made of a metal material, which can be an aluminium layer. Advantageously, the light emitting device 10 and the heating device 20 are connected with an AC or a DC driving circuit.

Applying a voltage to the electrodes of the light emitting device 10 or the heater 20 generates light or heat respectively. Examples are given in FIG. 5a,5b. In FIG. 5a the light device 10 is connected with DC driving circuit. The first and the second electrode 11,12 are supplied with different voltages. A current flow is provided in vertical direction, wherein light 40 is emitted by the light emitting element 13. In FIG. 5b an AC driving circuit is connected with the heating device 20. In order to generate heat radiation 41 the supplied voltage at the left side of the heating element 21 is different to the supplied voltage at the right side of the heating element 21. In this case a current flow is provided in horizontal direction, while heat radiation 41 is emitted. In other not shown embodiments it is also possible to combine the AC and DC driving circuit in one electrical system. That means that for example according to FIG. 5a the second electrode 12 can be driven additionally by an AC driving circuit. Thus, the second electrode 12 emits heat radiation 41, wherein light 40 is leaving the light emitting device 10. The voltage sources in the pictures—DC source for light generation and AC source for heat generation—are possible examples. Both voltage sources may either be DC, AC or pulsed voltage or current sources.

The electrical system 1 can comprise multiple OLEDs 13. In order to change easily the color of the light 40 leaving the electrical system 1 each OLED 13 can be connected with an individual driving circuit. Advantageously, the OLEDs 13 can display a single color or a plurality of colors. In order to achieve a multi-color display, it is apparent that a RGB selective deposition method can be used.

The light emitting device 10 according to the present embodiments is particularly configured to generate light for inside and outside providing a sufficient intensity of an effective illumination, whereby the term “light” includes visible and invisible light (e.g. UV, IR) or a combination of both. Furthermore, the heating element 21, the reflecting element 22 and/or the electrodes 11, 12 comprise a thickness less than 500 nm.

### LIST OF NUMERALS

1 electrical system
10 light emitting device
11 first electrode
12 second electrode
13 light emitting element, LED, OLED
20 heating device
21 heating element
22 reflecting layer
23 first cavity
24 second cavity
25 getter material
30 first panel
31 second panel
32 intermediate layer
33 surface of the electrical system
34 surface of the electrical system
40 light
41 heat radiation

1. An electrical system for producing light and heat radiation, the system comprising:
a first panel and a second panel, at least one of the first and the second panels comprising a light-transmissive material;
a light emitting device comprising a first electrode, a second electrode, and a light emitting element disposed between the first and the second electrodes,
a heating device comprising at least one heating element,
a first electric circuit for driving the light emitting device by a current flow between the first and the second electrode for emitting light radiation, and
a second electric circuit for driving the heat element by a current flow in a planar extension within the at least one heating element for emitting heat radiation,
wherein the light emitting device and the heating device are disposed between the first and the second panels, and
wherein the heat radiation and the light radiation propagate towards at least one of the first and the second panels and are released from the electrical system through a portion of an outer surface of the at least one of the first and the second panels.

2. The electrical system of claim 1, wherein a first cavity is defined between the at least one heating element and the first panel.

3. The electrical system in of claim 2, wherein the first panel comprises a reflecting layer for reflecting heat radiation towards the second panel.

4. (canceled)

5. The electrical system of claim 1, wherein at least one of the first and the second electrodes is reflective.

6. The electrical system of claim 1, wherein at least one of the first and second electrodes, the heating element and/or the reflecting layer comprise transparent metallic or metal-oxide layers disposed between the panels.

7. The electrical system of claim 1, wherein the light emitting device is an OLED, or comprises a plurality of light emitting elements, wherein each light emitting element is a LED or an OLED.

8. (canceled)

9. The electrical system of claim 1, wherein the light emitting device and the heating device are superimposed, the electrical system further comprising an intermediate layer disposed between the first electrode and the heating element.

10. (canceled)

11. The electrical system of claim 9, wherein the heating element is provided between the first panel and the intermediate layer.

12-17. (canceled)

18. An electrical system for producing light and heat radiation the system comprising:
a first panel and a second panel, at least one of the first and the second panels comprising a light-transmissive material;
a light emitting device disposed between the first and second panels and comprising a first electrode, a second electrode, and a light emitting element disposed between the first and the second electrodes, at least one of the first and second electrodes comprising a heating element configured to emit heat radiation;
a first electric circuit for driving the light emitting device by a current flow between the first and the second electrode for emitting light radiation, and
a second electric circuit for driving the heat element for emitting heat radiation,
wherein the heat radiation and the light radiation propagate towards at least one of the first and the second and are released from the electrical system through a portion of an outer surface of the at least one of the first and the second panels.

19. The electrical system of claim 1, wherein the second panel comprises the light-transmissive material and wherein the first panel comprises a reflecting layer for reflecting heat radiation towards the second panel.
